(19) United States
(12) Patent Application Publication
(10) Pub. No.: US 2023/0083762 A1
(43) Pub. Date: Mar. 16, 2023

(54) ADVERSARIAL BANDIT CONTROL LEARNING FRAMEWORK FOR SYSTEM AND PROCESS OPTIMIZATION, SEGMENTATION, DIAGNOSTICS AND ANOMALY TRACKING

(71) Applicant: Soumyajit DAS, Bangalore (IN)

(72) Inventor: Soumyajit DAS, Bangalore (IN)

(21) Appl. No.: 17/635,819

(22) PCT Filed: Oct. 26, 2021
(86) PCT No.: PCT/IN2021/051013

§ 371 Date: Feb. 16, 2022

(30) Foreign Application Priority Data
Sep. 9, 2021 (IN) 202141040849

(51) Int. Cl. G06N 20/20

(52) U.S. Cl. CPC G06N 20/20

(57) ABSTRACT

A system for execution of learning models in a controllable learning framework has a surface learning module that enables response surface learning or adaptive and active feature transfer learning of a model for a plurality of input variables of an input dataset. The learning model handles diagnostics with configuration recommendation as feature combination-based rules. An optimization module provides a set of rules for the learning model to accomplish multi-criteria multi-step optimization of the plurality of input variables and a plurality of response variables of the input dataset for multi constrained optimization. The learning model performs tracking of anomalies in one or more parameters associated with the input dataset while updating the learning model. A response segmentation module enables segmentation of the response variables of the input dataset by utilizing the learning model. A controllable segmentation module provides a controllable and configurable sensitive band embedding segmentation approach for the input variables.

### BACKGROUND

Embodiments of the present disclosure relate to a learning interface for executing a task and more particularly to an adversarial bandit control learning framework for system and process optimization, segmentation, diagnostic and anomaly tracking.

In computer systems, a framework is often a layered structure indicating what kind of programs may be or should be built and how they would interrelate. Some computer system frameworks also include actual programs, specify programming interfaces, or offer programming tools for using the frameworks. The framework may be for a set of functions within a system and how they interrelate to develop one or more applications with high-level functionality. There are several types of frameworks such as support programs, compilers, code libraries, toolsets, machine learning frameworks and application programming interfaces (APIs) that bring together all the different components to enable development of a learning system. Among all, the machine learning frameworks enable building and deployment of machine learning models for several industries notably finance, insurance, healthcare, manufacturing and marketing and the like in a much faster and easier way.

Conventionally, the machine learning based frameworks are designed based on one or more organization's requirements to develop or deploy the one or more machine learning models for one or more business problems. However, such conventional learning frameworks are unable to solve multiple optimization objectives related to yield or process life cycle of different products of the several industries. Also, such conventional frameworks utilise some methodologies which are unable to update or modify the hypothesis at any given time, based on its relevancy towards the business objective.

Hence, there is a need for an improved adversarial bandit control learning framework for system and process optimization, segmentation, diagnostic and anomaly tracking in order to address the aforementioned issues.

### Objective of the Invention

Learning model—Interpretable and flexible over hypothesis space (open to hand-picked rule)
Locality sensitive controllable band embedding segmentation—with granular vs bulk segment for different set of treatment (trade-off), hierarchical and semantic clustering module.
Flexibility and Interactive controls—self supervised or unsupervised learning can be controlled by using custom split points from user.
Dashboard index—determining the number of Interaction to report in eda module
Controllability vs optimization—optimal operating condition (rules with Both Side Definition—Min and Max, with unit specifications like: hz, rpm, grams etc).
Combined Feature selection (Interaction—index) and combined impact with stability analysis
Single model for Multi-phase data—process cycle optimization (Applicable only for same sensor or input vector across multiple phase)
Multi criteria multi step optimization—combined response optimization (multiple Y or Response variables)
Interval Prediction with lower and upper bound as well Rule set with both side boundaries and with unit specifications like grams, hz, ohm, Mol./wt., volt, watt, rpm etc.
Anomaly tracking and detection—band or rule fluctuations (RCA)
Systematic tracking of anomaly—sensitive var Subset
Missing Value Imputation and Feature Engineering Tool (Band or NLP or Sequence or DL—Adversarial learning model)
Auto EDA—Exploratory modules with respect to Response variables, Bivariate, Multivariate, univariate test modules.

### Brief Description

In accordance with an embodiment of present disclosure, an adversarial bandit control learning framework for system and process optimization, segmentation, diagnostic and anomaly tracking is disclosed. The system includes a processing subsystem hosted on a server. The processing subsystem is configured to execute on a network to control bidirectional communications among a plurality of modules. The processing subsystem includes a surface learning module configured to enable response surface learning of a learning model for a plurality of input variables of an input dataset, wherein the learning model handles diagnostics with configuration recommendation. The processing subsystem also includes an optimization module configured to provide a set of rules for the learning model to accomplish multi-criteria optimization of the plurality of input variables and a plurality of response variables of the input dataset. The processing subsystem also includes a response segmentation module configured to enable segmentation of the one or more response variables of the input dataset by utilizing the learning model. The processing subsystem also includes a controllable segmentation module configured to provide at least one of a controllable and configurable sensitive band embedding approach for the one or more response variables.

In accordance with an embodiment of the present disclosure, a system for performing supervised learning using an adversarial bandit control learning framework is disclosed. The system includes a processing subsystem hosted on a server. The processing subsystem is configured to execute on a network to control bidirectional communications among a plurality of modules. The processing subsystem includes an input receiving module configured to receive an input dataset comprising a plurality of input variables and one or more response variables arranged in a raw format. The processing subsystem also includes a data transformation module operatively coupled to the input receiving module. The data transformation module is configured to determine one or more split criteria corresponding to each of the plurality of input variables and the one or more response variables of the input dataset. The data transformation module is also configured to generate one or more data buckets from the input dataset for transformation of the input dataset based on the one or more split criteria, cardinality of the plurality of input variables and one or more bucketing factors of the plurality of input variables. The processing subsystem also includes a feature selection module operatively coupled to the data transformation module. The feature selection module is configured to create one or more band tree tables upon selection of one or more features from transformed input dataset based on application of the one or more split criteria and the one or more bucketing factors. The processing subsystem also includes an ensemble model generation module operatively coupled to the feature selection module. The ensemble model generation module is configured to select one or more samples from each of the one or more band tree tables created using a sampling technique. The ensemble model generation module is also configured to create one or more grid-based bandit control trees corresponding to each of the one or more column samples selected. The ensemble model generation module is also configured to calculate one or more response scores corresponding to each of the one or more grid-based bandit control trees created at a tree level. The ensemble model generation module is also configured to generate an ensemble learning model for prediction of an outcome based on a predefined requirement by combining each of the one or more grid-based bandit control trees upon calculation of the one or more response variables to predict scores. The ensemble model generation module is also configured to calculate an aggregated response score of the ensemble learning model for the prediction of the outcome by utilizing an aggregated and transformation function. The processing subsystem also includes a model regularization module operatively coupled to the ensemble model generation module. The model regularization module is configured to filter the one or more grid-based bandit control trees and the ensemble learning model based on each of the corresponding one or more prediction or Predictive power scores and the aggregated response score respectively. The processing subsystem also includes a model diagnosis module operatively coupled to the ensemble model generation module and the model regularization module, wherein the model diagnosis module is configured to compare performance of the ensemble learning model by utilizing residual diagnostics error Metrics, and quality score. The model diagnosis module is also configured to analyse sensitivity and stability of the one or more features significant to each of the one or more grid-based bandit control trees and the ensemble learning model.

The anomaly tracking module (125) is also configured to track unstability and fluctuations in plurality of input variables upon merging old band tree table data with new band tree table data based on one or more variables based on comparison of the ensemble model with a historical ensemble model upon incrementally updating the ensemble learning model; and detect and mark fluctuations from the ensemble model based on analysis of the sensitivity and the stability of at feature combinations and band level.

In accordance with another embodiment of the present disclosure, a method to operate an adversarial bandit control learning framework for system and process optimization, segmentation, diagnostic and anomaly tracking is disclosed. The method includes receiving, by an input receiving module, an input dataset comprising a plurality of input variables and one or more response variables arranged in a raw or transformed format. The method also includes determining, by a data transformation module, one or more split criteria corresponding to each of the plurality of input variables and the one or more response variables of the input dataset. The method also includes generating, by the data transformation module, one or more data buckets from the input dataset for transformation of the raw input dataset based on the one or more split criteria, cardinality of the plurality of input variables and one or more bucketing factors of the plurality of input variables. The method also includes creating, by a feature transformation and filtering module, one or more band tree tables upon selection of one or more features from transformed input dataset based on application of the one or more split criteria and the one or more bucketing factors. The method also includes selecting, by an ensemble model generation module, one or more samples from each of the one or more band tree tables created using a column sampling technique. The method also includes creating, by the ensemble model generation module, one or more grid-based bandit control trees corresponding to each of the one or more samples selected. The method also includes calculating, by the ensemble model generation module, one or more response variables corresponding to each of the one or more grid-based bandit control trees created at a every instance level. The method also includes generating, by the ensemble model generation module, an ensemble learning model for prediction of an outcome based on a predefined requirement by combining each of the one or more grid-based bandit control trees upon calculation of the one or more response scores. The method also includes calculating, by the ensemble model generation module, an aggregated and transformed response score of the ensemble learning model for the prediction of the outcome by utilizing an aggregated function. The method also includes filtering, by a model regularization module, the one or more learning models and the ensemble learning model based on each of the corresponding one or more response scores and the aggregated response score respectively.

The method also includes anomaly tracking coupled with incremental learning module, wherein the ensemble learning model with a historical ensemble model and newly formed ensemble model by utilizing table merging or joining operation based for auto incremental active feature transfers learning, one or more features combination or band for anomaly tracking and flagship.

The method also includes analysing, by the model diagnosis module, sensitivity and stability of the one or more features significant to each of the grid-based bandit control trees and the ensemble learning model.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a controllable learning framework in accordance with an embodiment of the present disclosure;

FIG. 2 is a schematic representation of a process of a llocality sensitive semantic band embedding—controllable segmentation iterative approach in accordance with an embodiment of a present disclosure;

FIG. 3 is a block diagram representation of a system for performing supervised learning using a controllable learning framework in accordance with an embodiment of the present disclosure;

FIG. 4 is a schematic representation of an application of feature engineering in other modules of a controllable learning framework in accordance with an embodiment of the present disclosure;

FIG. 5 is a schematic representation of incremental and simultaneous learning instance and classification and regression in same instance with auto incremental procedure of FIG. 2 in accordance with an embodiment of the present disclosure;

FIG. 6 represents a schematic representation of a regularization process and combined feature impact index for dashboard scoring of FIG. 2 in accordance with an embodiment of the present disclosure;

FIG. 7 represents a schematic representation of an anomaly tracking process of a system of FIG. 2 in accordance with an embodiment of the present disclosure;

FIG. 8 is a schematic representation of an exemplary embodiment of a system for performing supervised learning using a controllable learning framework of FIG. 1 in accordance with an embodiment of the present disclosure;

FIG. 9 is a block diagram of a computer or a server in accordance with an embodiment of the present disclosure;

FIG. 10 (a) and FIG. 10 (b) is a flow chart representing the steps involved in a method for performing supervised learning using a controllable learning framework in accordance with an embodiment of the present disclosure;

FIG. 11 is a flowchart representing the steps involved in a method for performing locality sensitive hierarchical band embedding-controllable segmentation non-iterative approach in accordance with an embodiment of a present disclosure;

FIG. 12 is a flowchart representing the steps involved in a method for performing locality sensitive semantic band embedding-controllable segmentation-iterative approach in accordance with an embodiment of a present disclosure;

FIG. 13 (slide 4) is an exemplary bucket or splitting step, in accordance with an embodiment of the present disclosure;

FIG. 14 (slide 5) is an exemplary band tree table formation after applying different split criteria, in accordance with an embodiment of the present disclosure;

FIG. 15 (slide 6 and 7) is an exemplary band tree table ensemble prediction—Regularization step, in accordance with an embodiment of the present disclosure; and

FIG. 16 (slide 10) is an exemplary anomaly tracking and band update method, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to an adversarial bandit control learning framework for system and process optimization, segmentation, diagnostic and anomaly tracking is disclosed. The system includes a processing subsystem hosted on a server. The processing subsystem is configured to execute on a network to control bidirectional communications among a plurality of modules. The processing subsystem includes a surface learning module configured to enable surface learning or adaptive and active feature transfers learning of a model for a plurality of input variables of an input dataset, wherein the learning model handles configuration recommendation. The processing subsystem also includes an optimization module configured to provide a set of rules for the learning model to accomplish multi-criteria and multi-phase optimization of the plurality of input variables and a plurality of response variables of the input dataset. The processing subsystem may also include a recommendation module configured to generate one or more recommendations to a user based on the analysed sensitivity and stability of the one or more features significant to each of the grid-based bandit control trees and the ensemble learning model, wherein the one or more recommendations comprises key performance indicators.

The processing subsystem also includes an anomaly tracking module 125 configured to enable the learning model to track one or more anomalies in one or more parameters associated with the input dataset based on the fluctuation in the data specifically band or feature combination level. For univariate and bivariate level similarity, dissimilarity and fluctuations measure for different time segments and different sample size using bucketized quality and tracking metrics for hypothesis test.

The processing subsystem also includes a response segmentation module configured to enable segmentation of the one or more response variables of the input dataset by utilizing the learning model. The processing subsystem also includes a controllable segmentation module configured to provide at least one of a controllable and configurable locality sensitive band embedding approach for the plurality of input variables.

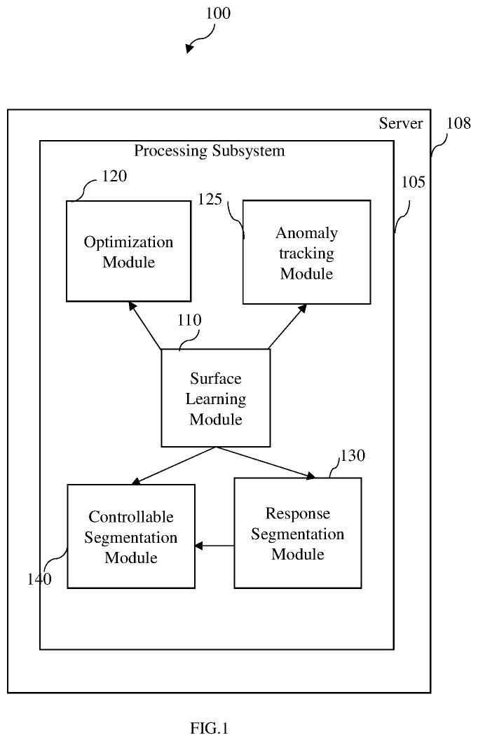

FIG. 1 is a block diagram representation of a system (100) of a controllable learning framework in accordance with an embodiment of the present disclosure. The system (100) includes a processing subsystem (105) hosted on a server (108). In one embodiment, the server (108) may include a cloud server. In another embodiment, the server (108) may include a local server with multiple processing GPU enabled and high parallelization enabled and fast streaming 10 processors for streaming data in real time as well as from cloud servers. These system processes the data in a multi-threaded, distributed and parallelized manner with multi-GPU processors like Spark with CUDA enabled system and the like. The processing subsystem (105) is configured to execute on a network (not shown in FIG. 1) to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like. The processing subsystem (105) includes a surface learning module (110) configured to enable surface learning of a learning model for a plurality of input variables of an input dataset, wherein the learning model handles configuration recommendation. The surface learning module (110) enables missing value imputation, feature engineering, data generation process, multivariate interaction extraction and stable operating conditions. The surface learning module also enables combined feature selection. Upon the combined feature selection, a response index and combined impact or stability analysis is done.

The processing subsystem (105) also includes an optimization module (120) configured to provide a set of rules for the learning model to accomplish multi-criteria, multi-phase and multi-step optimization of the plurality of input variables and a plurality of response variables of the input dataset. The optimization module (120) enables design of a single model for multi-phase data and thus helps in process cycle optimization. The optimization module (120) handles controllability vs optimization trade-off. Thus, the optimization module (120) solves multi criteria and multi-phase optimization of the input variables along with combined response variable for constrained optimization.

Bucketized quality and tracking metrics for the input variables, for example, for Variable 1: random var Var2: random var, Bucket or Discretize var1 and var2 (10 to 100 bin). Get univariate or transformation measures at every bucket (mean, median, moments, univariate measures etc). Apply deviance, or distance, similarity and dissimilarity: mse, mape, correlation, decorrelation and the like. An objective of quality and tracking metrics includes scenario tracking and testing applicable for different sample size and time cohort-hypothesis testing. This method is similar to the anomaly tracking module 125 for univariate and bivariate level tracking.

The processing subsystem (105) also includes a response segmentation module (130) configured to enable segmentation of the one or more response variables of the input dataset by utilizing the learning model. The response segmentation module (130) is configured to bucketize or perform binning on one or more response variables at a percentile or decile level. The response segmentation module (130) also use a bandit control tree or forest for classification of multiple segments of the one or more response variables as individual class.

The processing subsystem (105) also includes a controllable segmentation module (140) configured to provide at least one of a controllable and configurable locality sensitive band embedding approach for the plurality of input variables. The clustering technique is applicable for both tabular as well as unstructured form of data, wherein the unstructured form of data may include text format of data which may be processed using natural language processing techniques. The controllable segmentation approach are of 2 types such as controllable segmentation non-iterative approach and controllable segmentation iterative approach. In case of locality sensitive hierarchical band embedding—controllable segmentation or non-iterative approach, based on collection of band or tree, without any response var ‘Y’,

A= for all continuous and bucketized input vars with univariate attribute vector,

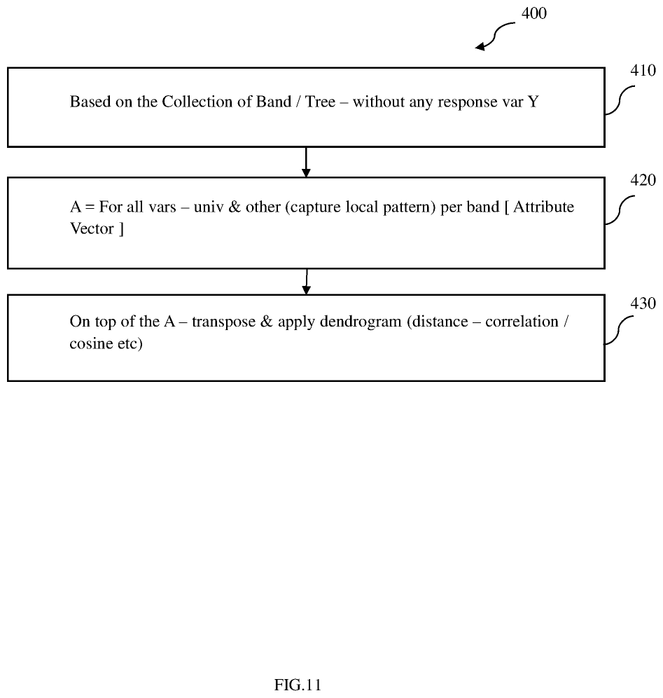

On top of the A, compute transpose and apply dendrogram as shown in FIG. 11.

The controllable segmentation module (140) also performs cluster control and modifies cluster shifting from low utility point to high utility point. Also, other application areas of response segmentation include profile customization for segment control, flexible structure mapping, locality embedding and adaptive targeting Such representation of the locality sensitive hierarchical band embedding—controllable segmentation or non-iterative approach is depicted below in Table 1:

Input=D [M*N] and with bucketing, only for continuous vars

TABLE 1

| X1 | X2 | X3 | X4 | Xn |
|---|---|---|---|---|
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |

[symbol]

indicates data missing or illegible when filed

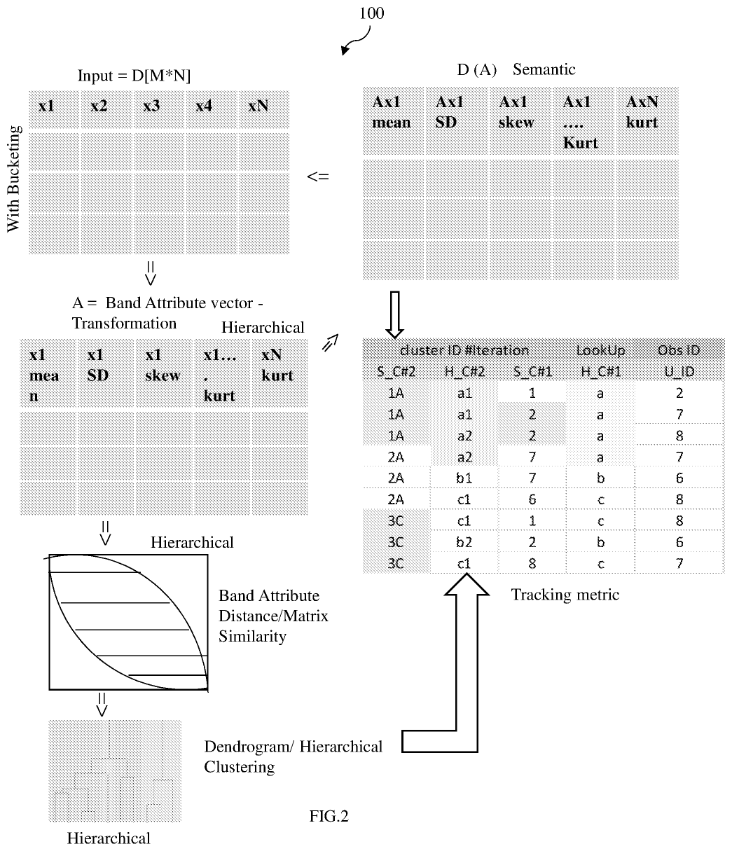

A=band Attribute Vector—aggregated and Transformational which is represented below in Table 2 as well as in FIG. 2:

TABLE 2

| | X1std | | | |
|---|---|---|---|---|
| X1mean | deviation | X1skew | . . . | Xn Kurtosis |
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |

[symbol]

indicates data missing or illegible when filed

Once, the attribute vector is obtained upon transformation, band attribute distance matrix similarity is calculated on transposed-band attributes vector. Various band attribute distance matrix includes at least one of 12, cosine, Jaccard, product moment, lattice, inner product moment, outer product moment and the like. The band attribute distance matrix is shown below as follows in graph 1:

Further from the band attribute distance matrix, dendrograms or hierarchical clustering is performed as represented below:

Again, in case of the locality sensitive semantic band embedding—controllable segmentation iterative approach,

D=M X N [(X, Y [optional—all categorial and response related components]) with response vars Y (count or mean or univariate or transformation-segment by)],

Filter by top feature N->k, k<=N

Step—Shrinkage (Band formation based on Attribute vector)

```
  {
    D => B [ Based on the Collection of Band or Tree - with or out any
response var Y],
    A = For all variables: univariate and other (capture local pattern) per
band [ Attribute Vector]
  }
```

A=>D1 [with response vars Y (count or mean or univariate or transformation-segment by)]

Apply Shrink on D1 to get A1,

A1=>D2 [with response vars Y (count or mean or univariate or transformation-segment by)]

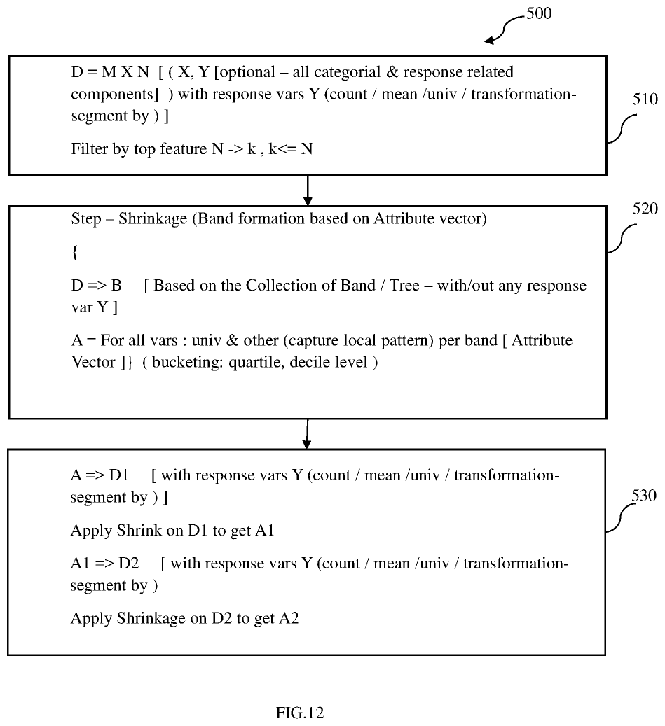

Apply Shrink on D2 to get A2 as shown in FIG. 12.

Therefore, E0=> On top of the A— compute transpose and apply dendrogram. Such same process as the non-iterative approach is further followed. Here, the row space shrinks and the column space expands and this process continues to get smaller clustering numbers.

The locality sensitive semantic band embedding—controllable segmentation iterative approach is depicted below as follows:

Input=D [M*N] and with bucketing, only for continuous vars

TABLE 1

| X1 | X2 | X3 | X4 | Xn |
|---|---|---|---|---|
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |

[symbol]

indicates data missing or illegible when filed

A=band Attribute Vector—aggregated and Transformational which is represented below in Table 2:

TABLE 2

| | | x1 | x1 | Xn |
|---|---|---|---|---|
| x1 mean | x1 Sd | Skew | kurt . . . | kurt |
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |

[symbol]

indicates data missing or illegible when filed

Further, once, the attribute vector is obtained upon transformation, band attribute distance matrix similarity is calculated on transposed-band attributes vector. Various band attribute distance matrix includes at least one of 12, cosine, Jaccard, product moment, lattice, inner product moment, outer product moment and the like. The band attribute distance matrix is shown below as follows in graph 1:

Further from the band attribute distance matrix, dendrograms or hierarchical clustering is performed as represented in FIG. 2.

Again, D(A) is represented as below:

TABLE 3

| | | Ax1 | Ax1 | |
|---|---|---|---|---|
| Ax1 mean | Ax1 S3d | Skew | kurt . . . | Axn kurt |
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |

[symbol]

indicates data missing or illegible when filed

The controllable segmentation iterative method is also used for granular vs bulk segmentation as well as for profile or treatments. The flexibility for granular vs bulk targeting, movement in granular segments is treated in a very specific way but it might fall in a larger bucket or bulk bucket which may be treated in a very generalized or a broad way. We can use this trade-off to adjust or control the segment as per business requirements.

Application on tabular data: dynamic ad targeting, drug trials or test, profiles or patient of state evaluation, crop seed profiling and treatment.

Application on text or the natural language processing: on text or word semantic (pca, lda, lsi) or co-occurrence (autoencoder, glove, word2vec) representation matrix-> semantic segmentation, topic hierarchy extraction model, multi attribute record linkage, Graph Analytics and mining, social network profile tracking, network analysis based on degree distribution and other network attributes.

Validation or evaluation: standard procedure-homogeneity measure, H and V measures, Dunn and CH index, silhouette score, CPCC index, within or between groups dissimilarity measures can be used to evaluate the process (to get best cluster number) and validation. Again, a schematic representation of the locality sensitive semantic band embedding—controllable segmentation iterative approach is represented in FIG. 2.

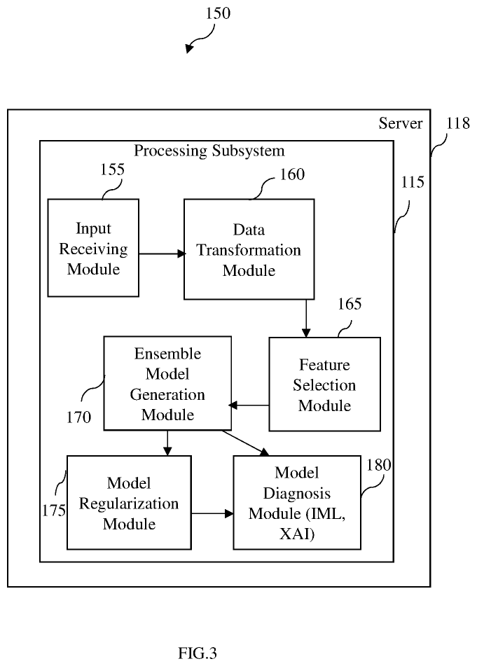

FIG. 3 is a block diagram representation of a system (150) for performing supervised learning using a controllable learning framework in accordance with an embodiment of the present disclosure. The system (150) includes a processing subsystem (115) hosted on a server (118). In one embodiment, the server (118) may include a cloud server. In another embodiment, the server (118) may include a local server. The processing subsystem (115) is configured to execute on a network to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like. The processing subsystem (115) is configured to execute on a network to control bidirectional communications among a plurality of modules. The processing subsystem (115) includes an input receiving module (155) configured to receive an input dataset comprising a plurality of input variables and one or more response variables arranged in a raw format. In one embodiment, the plurality of input variables may include a plurality of independent variables. In another embodiment, the one or more response variables may include one or more dependent variables.

The processing subsystem (115) also includes a data transformation module (160) operatively coupled to the input receiving module (155). The data transformation module (160) is configured to determine one or more split criteria corresponding to each of the plurality of input variables and the one or more response variables of the input dataset. In one embodiment, the one or more split criteria may include a dependent split criteria associated with the one or more dependent variables. In such embodiment, the dependent split criteria may include at least ChiMerge, minimum description length principle, khiops, adaptive quantizer, class-attribute interdependence maximization, pointwise mutual information and maximal information coefficient. In another embodiment, the one or more split criteria may include an independent split criteria associated with the one or more response variables. In such embodiment, the independent split criteria may include at least one of a flat cut criteria, percentile level criteria or decile level criteria.

The data transformation module (160) is also configured to generate one or more data buckets from the input dataset for transformation of the input dataset based on the one or more split criteria, cardinality of the plurality of input variables and one or more bucketing factors of the plurality of input variables. In one embodiment, the one or more bucketing factors may include at least one of signal to noise ratio (SNR), standard deviation (SD), variable subset index or a combination thereof. The variable subset index is represented as:

N/2,Log(N),nCk, where(K<N) (1)

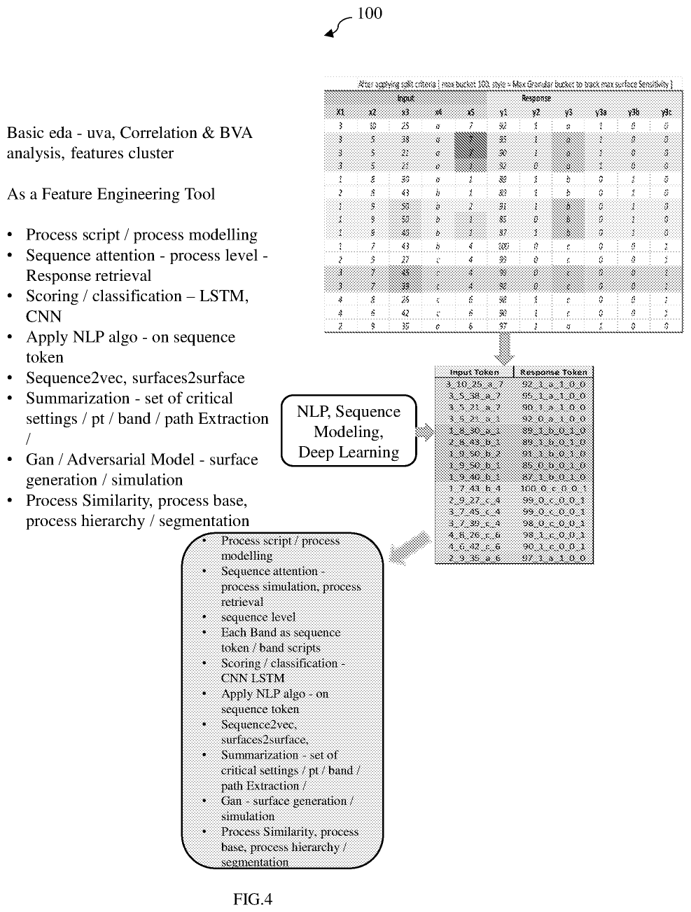

The processing subsystem (115) also includes a feature selection module (165) operatively coupled to the data transformation module (160). The feature selection module (165) is configured to create one or more band tree tables upon selection of one or more features from transformed input dataset based on application of the one or more split criteria and the one or more bucketing factors. One such embodiment of application of feature engineering in all other modules is depicted in FIG. 4.

The processing subsystem (115) also includes an ensemble model generation module (170) operatively coupled to the feature selection module (165). The ensemble model generation module (170) is configured to select one or more samples from each of the one or more band tree tables created using a column sampling technique. As used herein, the term ‘ensemble learning model’ is defined as a computational model which uses multiple statistical and machine learning methods to obtain better predictive performance than could be obtained from any of the constituent learning methods alone.

The ensemble model generation module (170) is also configured to create one or more grid-based bandit control trees corresponding to each of the one or more samples selected. The ensemble model generation module (170) is also configured to calculate one or more response scores corresponding to each of the one or more grid-based bandit control trees created at a tree level. The ensemble model generation module (170) is also configured to generate an ensemble learning model for prediction of an outcome based on a predefined requirement by combining each of the one or more learning models upon calculation of the one or more response scores. In a specific embodiment, the prediction includes at least a binary classification, a multiclass classification, a regression or scoring. In such embodiment, the binary classification and the multiclass classification is performed based on calculation of weighted average, probability or class prediction for one or more bands of the one or more band tree tables. In some embodiment, the regression is performed based on calculation of average, median of the one or more bands of the one or more band tree tables.

The ensemble model generation module (170) is also configured to calculate an aggregated response score of the ensemble learning model for the prediction of the outcome by utilizing an aggregated function. The aggregated response score includes at least one of population stability index (PSI), r-squared measure, mad and mean absolute error (MAE), cross entropy (CE), information content, area under curve (AUC) of receiver operation characteristic (ROC), mean squared error (MSE) or a combination thereof. Time complexity of the prediction such as regression as well as classification for the outcome by the learning model is depicted as follows: O (k*n log (n)), where {k=instance numbers, nlog(n)=per instances time complexity for one band tree for both regression and Classification base version}

Exploratory Modules: Regression 2 Classification

Bucketized or binning of continuous response var Y: percentile, decile level. Use grid-based control learning tree for classification (multiple bucket of Y represents individual class of response variable.

The ensemble learning module also enables simulation at a grid level to generate data for data augmentation.

For example, For a var a1 At a grid level a1 [i]: μ1, σ1, {observed attributes}
Generate data at grid level: μ1, σ1: +−σ1*€, where €: 1.96, 2.58.

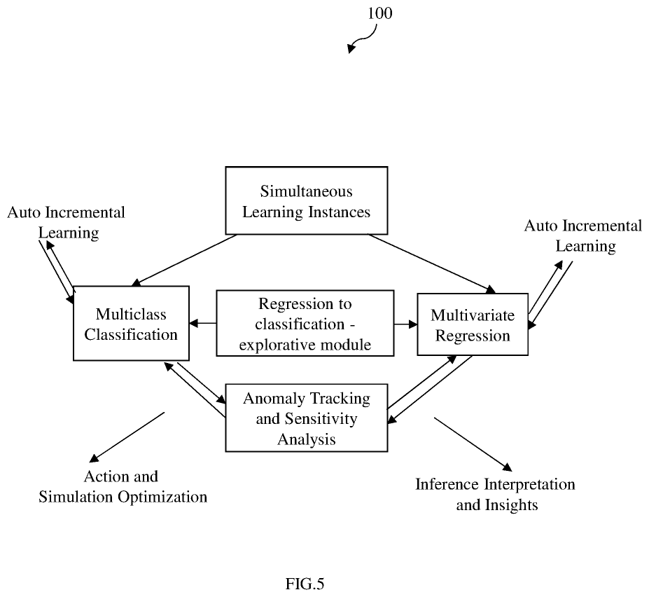

The ensemble learning module enables simultaneous learning per instances in case of supervised learning. The simultaneous learning per instances are possible for multiclass classification, multivariate regression at same learning instances with hypothesis merge. Prediction with interval is also possible for regression. Again, a schematic representation of incremental and simultaneous learning instance and classification and regression in same instance with auto incremental procedure is shown in FIG. 5.

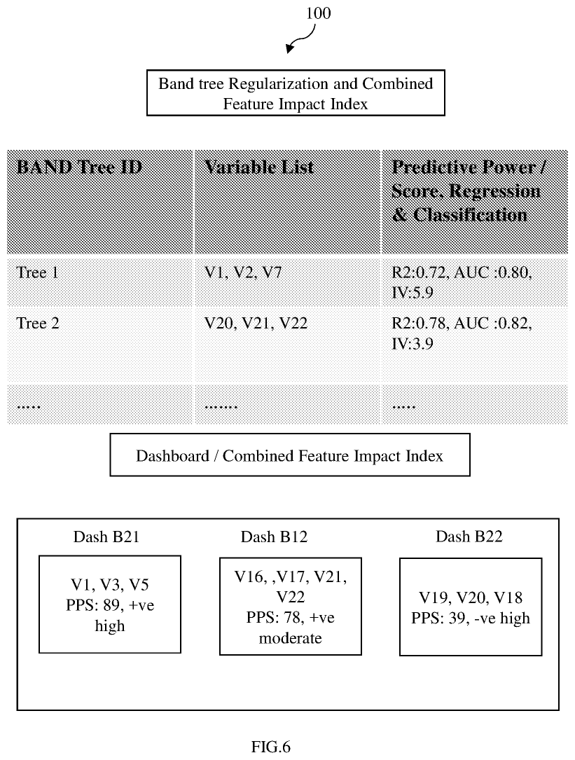

The processing subsystem (115) also includes a model regularization module (175) operatively coupled to the ensemble model generation module (170). The model regularization module (175) is configured to filter the one or more grid-based bandit control trees and the ensemble learning model based on each of the corresponding one or more response scores and the aggregated response score respectively. The model regularization module (175) utilizes band level pruning as well as tree level pruning and combined interaction index or dashboard scoring and individual feature ranking. The band level pruning or the rules-based pruning filters band by number of supporting observations or high residual and high fluctuation at rule or band level. Again, the tree table pruning utilizes predictive power or the response score associated to single tree and filter band tree tables by combined interaction index or dashboard score such as Information content, information value (IV), R2, AUC, WOE, info content weight. Validate with training split rule to check psi, surfaces or band tree fluctuation for dashboard scoring. The dashboard created based on predictive power of each of the trees and enables addition of such information of the tree in the dashboard. A schematic representation of the regularization process is depicted in FIG. 6.

Hyperparameters of the grid-based bandit control trees includes:

Split range—10-100 (continues variables with specific granularity) [Higher Split range-high variance model]— stability issue in long run, [lower split range—low variance model], wherein the Split or bucket size—based on cardinality and few other SNR, SD) factor from input vars (unique point divided by total observations)

Again, Var Subset index—sqrt (tot vars), n/2, log(n) . . . , and the like.

Further, Split criteria—binning or discretization: ChiMerge, MDLP, CAIM, khiops, Adaptive Quantizer, mutual Information based: PMI, MIC, change point, covariance or density or contour based and the like.

Band tree Table Weight score— IV, AUC, R2 . . . and the like.

Similarly, Prediction—get count, average, weighted average, class, probability.

Out of bag sample size: 30%

Fluctuations pruning: true or false (warm up or incremental addition)

The processing subsystem (115) also includes a model diagnosis module (180) operatively coupled to the ensemble model generation module (170) and the model regularization module (175). The model diagnosis module (180) is configured to compare performance of the ensemble learning model by utilizing residual diagnostics error Metrics, and quality score. The model diagnosis and inferences or interpretation machine learning (IML) or explainable artificial intelligence (XAI) module (180).

In one embodiment, the one or more residual diagnostic parameters may include at least one of the aggregated response score, confusion matrix or rank order checking. The model diagnosis module (180) is also configured to analyse sensitivity and stability of the one or more features significant to each of the one or more grid-based bandit control trees and the ensemble learning model.

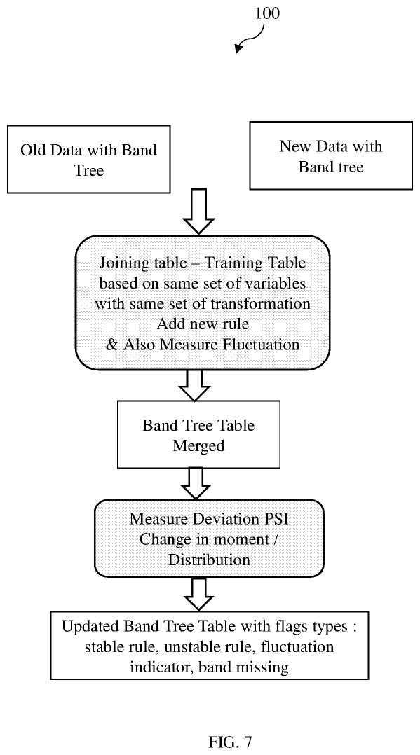

The anomaly tracking module 125 helps in identifying or flag out fluctuations in band or features combination or input or feature sets, detection, RCA and sensitivity analysis based on comparison of the training band tree and New band tree. The anomaly tracking and sensitivity analysis helps in flag out features combination—band or rule fluctuation. The anomaly tracking helps in identifying some new rule which might appear in data and few old rule which might become insignificant due to fluctuation. A block diagram representation of the anomaly tracking process is depicted in FIG. 7.

Further, the system provides an interactive controls for supervised and unsupervised learning models based on user input, wherein supervised and unsupervised learning model is controlled by using custom split points from user.

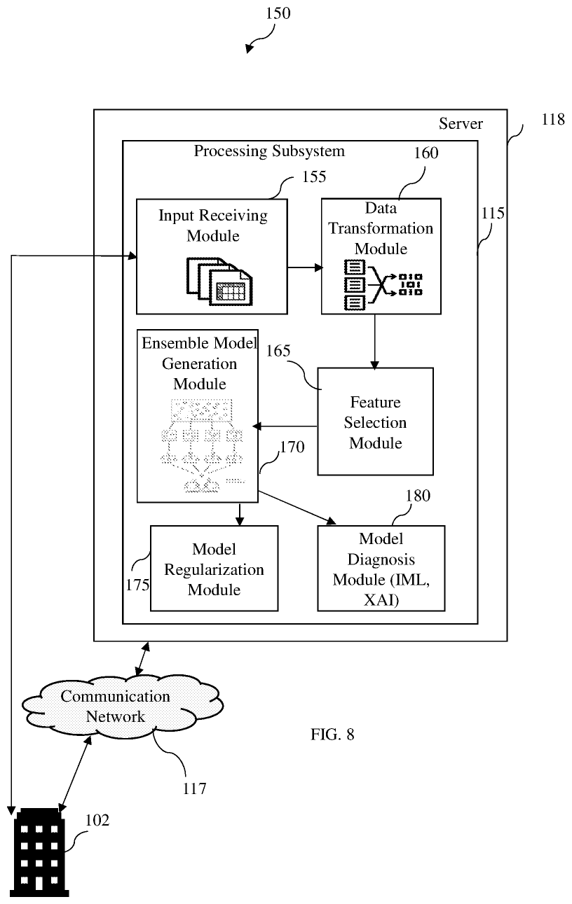

FIG. 8 is a schematic representation of an exemplary embodiment of a system (150) for performing supervised learning using a controllable learning framework of FIG. 1 in accordance with an embodiment of the present disclosure. Considering an example, where the system (150) is utilized for product life cycle optimization in an organization (102). Here, the organization (102) communicates with a processing subsystem (115) via a wireless communication network (117), wherein the processing subsystem (115) is hosted on a cloud server (118) and it includes a plurality of modules for performing supervised learning. For optimization process, input data associated with the product is essential. Let's consider that the input dataset is available in raw format, wherein the input dataset includes a plurality of product attributes as a plurality of independent variables and one or more response variables such as unit count, yield, quality class and the like. In the example used herein, let's assume that dimension of the input data is 10 million (M) records×200 input variables or columns. So, total full batch=2000.

Once, the raw input dataset is obtained, a data transformation module (160) determines one or more split criteria corresponding to each of the plurality of input variables and the one or more response variables of the input dataset. For example, the one or more split criteria may include a dependent split criteria associated with the one or more response variables. In such an example, the dependent split criteria may include at least ChiMerge, minimum description length principle, khiops, adaptive quantizer, class-attribute interdependence maximization-pointwise mutual information (PMI), maximal information coefficient (MIC), a change point, covariance, density, or contour-based criteria. In another example, the one or more split criteria may include an independent split criteria associated with the one or more input variables. For example, the independent split criteria may include at least one of a flat cut criteria, percentile level criteria or decile level criteria.

Again, the data transformation module (160) is also to generate one or more data buckets from the input dataset for transformation of the input dataset based on the one or more split criteria, cardinality of the plurality of input variables and one or more bucketing factors of the plurality of input variables. For example, the one or more bucketing factors may include at least one of signal to noise ratio (SNR), standard deviation (SD), variable subset index or a combination thereof.

Based on the application of the one or more split criteria and the one or more bucketing factors, a feature selection module (165) creates one or more band tree tables upon selection of one or more features from transformed input dataset. Further, an ensemble model generation module (170) is configured to select one or more samples from each of the one or more band tree tables created using a sampling technique. The ensemble model generation module (170) is also configured to create one or more grid-based bandit control trees corresponding to each of the one or more samples selected. The ensemble model generation module (170) is also configured to calculate one or more response scores corresponding to each of the one or more grid-based bandit control trees created at a tree level. The ensemble model generation module (170) is also configured to generate an ensemble learning model for prediction of an outcome based on a predefined requirement by combining each of the one or more grid-based bandit control trees upon calculation of the one or more response scores. For example, the prediction includes at least a binary classification, a multiclass classification, a regression or scoring. In such embodiment, the binary classification and the multiclass classification is performed based on calculation of weighted average, probability or class prediction for one or more bands of the one or more band tree tables. In some embodiment, the regression is performed based on calculation of average, median of the one or more bands of the one or more band tree tables.

Also, the ensemble model generation module (170) is configured to calculate an aggregated response score of the ensemble learning model for the prediction of the outcome by utilizing an aggregated function. The aggregated response score includes at least one of population stability index (PSI), r-squared measure, mad and mean absolute error (MAE), cross entropy (CE), information content, area under curve (AUC) of receiver operation characteristic (ROC), mean squared error (MSE) or a combination thereof.

Further, based on each of the corresponding one or more response scores and the aggregated response score respectively, a model regularization module (175) filters the one or more grid-based bandit control trees and the ensemble learning model.

In addition, once, the model is ready and running we can use it for anomaly tracking and cumulative band update.

The anomaly tracking module 125 is also configured to track unstability and fluctuations in plurality of input variables upon merging old band tree table data with new band tree table data based on one or more variables based on comparison of the ensemble model with a historical ensemble model upon incrementally updating the ensemble learning model; and detect and mark fluctuations from the ensemble model based on analysis of the sensitivity and the stability at feature combinations and band level.

In the example used herein, the one or more residual diagnostic parameters may include at least one of the aggregated response score, confusion matrix or rank order checking. The model diagnosis module (180) is also configured to analyse sensitivity and stability of the one or more features significant to each of the one or more grid-based bandit control trees and the ensemble learning model. In a particular embodiment, the model diagnosis module (180) is also configured to eliminate one or more insignificant features from the ensemble model based on analysis of the sensitivity and the stability of the one or more features.

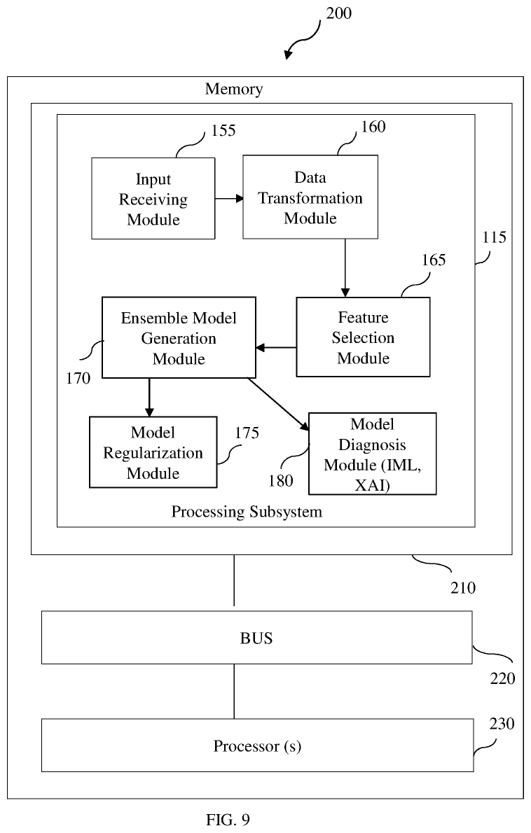

FIG. 9 is a block diagram of a computer or a server (200) in accordance with an embodiment of the present disclosure. The server (200) includes processor(s) (230), and memory (210) operatively coupled to the bus (220). The processor(s) (230), as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory (210) includes several subsystems stored in the form of executable program which instructs the processor (230) to perform the method steps illustrated in FIG. 1. The memory (210) includes a processing subsystem (115) of FIG. 1. The processing subsystem (115) further has following modules: an input receiving module (155), a data transformation module (160), a feature selection module (165), a transcript broadcasting module (170), a model regularization module (175) and a model diagnosis module (180).

The input receiving module (155) is configured to receive an input dataset comprising a plurality of input variables and one or more response variables arranged in a raw format. The data transformation module (160) is configured to determine one or more split criteria corresponding to each of the plurality of input variables and the one or more response variables of the input dataset. The data transformation module (160) is also configured to generate one or more data buckets from the input dataset for transformation of the input dataset based on the one or more split criteria, cardinality of the plurality of input variables and one or more bucketing factors of the plurality of input variables. The feature selection module (165) is configured to create one or more band tree tables upon selection of one or more features from transformed input dataset based on application of the one or more split criteria and the one or more bucketing factors. The ensemble model generation module (170) is configured to select one or more samples from each of the one or more band tree tables created using a sampling technique. The ensemble model generation module (170) is also configured to create one or more grid-based bandit control trees corresponding to each of the one or more samples selected. The ensemble model generation module (170) is also configured to calculate one or more response scores corresponding to each of the one or more learning models created at a tree level. The ensemble model generation module (170) is also configured to generate an ensemble learning model for prediction of an outcome based on a predefined requirement by combining each of the one or more grid-based bandit control trees upon calculation of the one or more response scores. The ensemble model generation module is also configured to calculate an aggregated response score of the ensemble learning model for the prediction of the outcome by utilizing an aggregated function. The model regularization module (175) is configured to filter the one or more grid-based bandit control trees and the ensemble learning model based on each of the corresponding one or more response scores and the aggregated response score respectively. The model diagnosis module (180) is configured to compare performance of the ensemble learning model by utilizing residual diagnostics error Metrics, quality score. The model diagnosis module (180) is also configured to analyse sensitivity and stability of the one or more features significant to each of the one or more grid-based bandit control trees and the ensemble learning model.

The anomaly tracking module 125 is configured to track unstability and fluctuations in plurality of input variables upon merging old band tree table data with new band tree table data based on one or more variables based on comparison of the ensemble model with a historical ensemble model upon incrementally updating the ensemble learning model; and detect and mark fluctuations from the ensemble model based on analysis of the sensitivity and the stability of at feature combinations and band level.

The bus (220) as used herein refers to be internal memory channels or computer network that is used to connect computer components and transfer data between them. The bus (220) includes a serial bus or a parallel bus, wherein the serial bus transmits data in bit-serial format and the parallel bus transmits data across multiple wires. The bus (220) as used herein, may include but not limited to, a system bus, an internal bus, an external bus, an expansion bus, a frontside bus, a backside bus and the like.

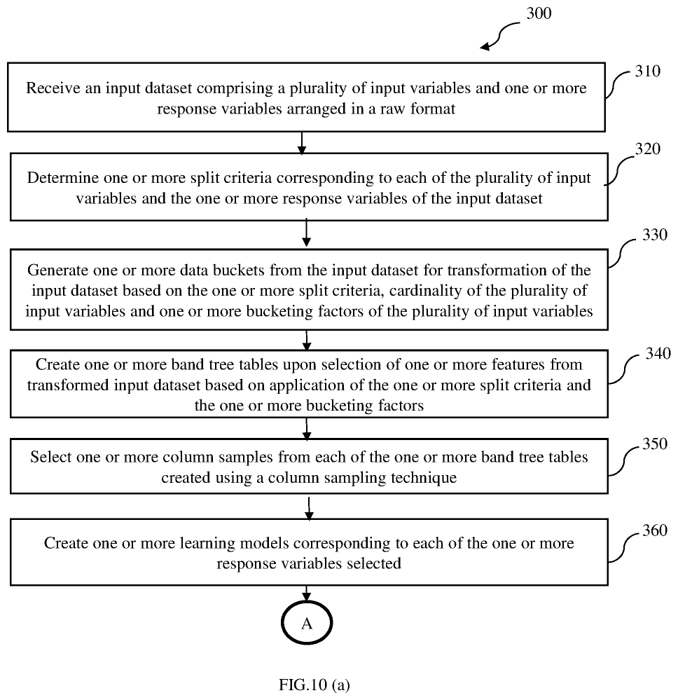

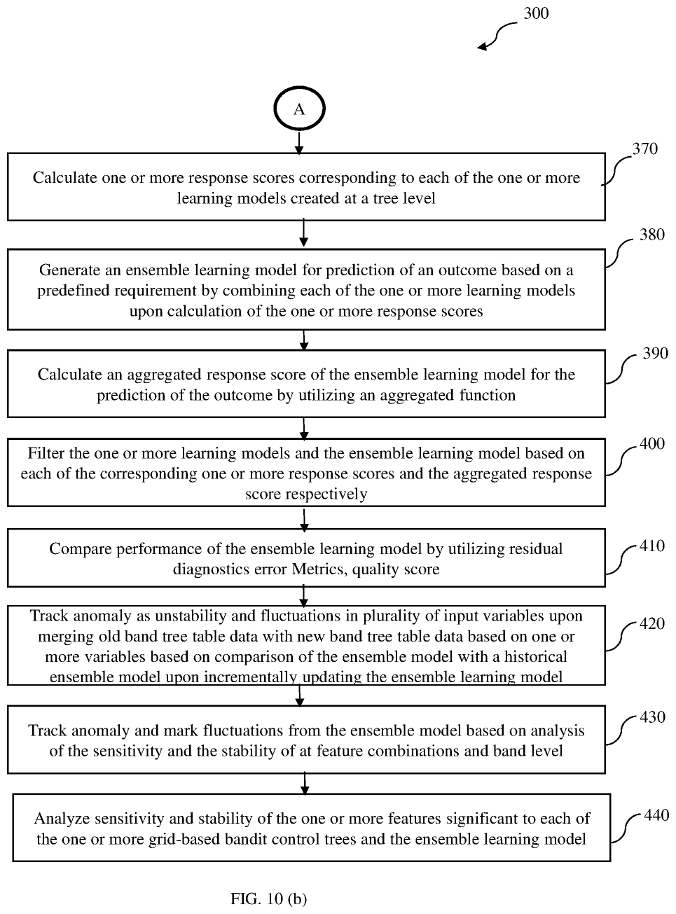

FIG. 10 (a) and FIG. 10 (b) is a flow chart representing the steps involved in a method (300) for performing supervised learning using a controllable learning framework in accordance with an embodiment of the present disclosure. The method (300) includes receiving, by an input receiving module, an input dataset comprising a plurality of input variables and one or more response variables arranged in a raw format in step 310. In one embodiment, receiving the input dataset with the plurality of input variables may include receiving a plurality of independent variables. In another embodiment, receiving the one or more response variables may include receiving one or more dependent variables.

The method (300) also includes determining, by a data transformation module, one or more split criteria corresponding to each of the plurality of input variables and the one or more response variables of the input dataset in step 320. In one embodiment, determining the one or more split criteria corresponding to each of the plurality of input variables and the one or more response variables may include determining the one or more split criteria may include an independent split criteria associated with the one or more independent variables. In such embodiment, the dependent split criteria may include at least ChiMerge, minimum description length principle, khiops, adaptive quantizer, class-attribute interdependence maximization, pointwise mutual information (PMI), a maximal information coefficient (MIC), a change point, covariance, density, or contour-based criteria. In another embodiment, the one or more split criteria may include an independent split criteria associated with the one or more input or independent variables. In such embodiment, the independent split criteria may include at least one of a flat cut criteria, percentile level criteria or decile level criteria.

The method (300) also includes generating, by the data transformation module, one or more data buckets from the input dataset for transformation of the input dataset based on the one or more split criteria, cardinality of the plurality of input variables and one or more bucketing factors of the plurality of input variables in step 330. In one embodiment, generating the one or more data buckets from the input dataset for the transformation of the input dataset based on the one or more bucketing factors may include generating the one or more data buckets based on at least one of signal to noise ratio (SNR), standard deviation (SD), variable subset index or a combination thereof.

The method (300) also includes creating, by a feature selection module, one or more band tree tables upon selection of one or more features from transformed input dataset based on application of the one or more split criteria and the one or more bucketing factors in step 340. The method (300) also includes selecting, by an ensemble model generation module, one or more samples from each of the one or more band tree tables created using a sampling technique in step 350. The method (300) also includes creating, by the ensemble model generation module, grid-based bandit control trees corresponding to each of the one or more samples selected in step 360.

The method (300) also includes calculating, by the ensemble model generation module, one or more response scores corresponding to each of the one or more grid-based bandit control trees created at a tree level in step 370. The method (300) also includes generating, by the ensemble model generation module, an ensemble learning model for prediction of an outcome based on a predefined requirement by combining each of the one or more grid-based bandit control trees upon calculation of the one or more response scores in step 380. In one embodiment, generating the ensemble learning model for the prediction of the outcome based on the predefined requirement may include generating the learning model for the prediction which includes at least a binary classification, a multiclass classification, a regression or scoring. In such embodiment, the binary classification and the multiclass classification is performed based on calculation of weighted average, probability or class prediction for one or more bands of the one or more band tree tables. In some embodiment, the regression is performed based on calculation of average, median of the one or more bands of the one or more band tree tables.

The method (300) also includes calculating, by the ensemble model generation module, an aggregated response score of the ensemble learning model for the prediction of the outcome by utilizing an aggregated function in step 390. In some embodiment, calculating the aggregated response score of the ensemble learning model for the prediction of the outcome may include calculating the aggregated response score which includes at least one of population stability index (PSI), r-squared measure, mean absolute error (MAE), KS stats or score, cross entropy (CE), information content, area under curve (AUC) of receiver operation characteristic (ROC), mean squared error (MSE) or a combination thereof.

The method (300) also includes filtering, by a model regularization module, the one or more learning models and the ensemble learning model based on tree level pruning from ensemble learning model and band level pruning from band tree table in step 400. The method (300) also includes comparing, by the model regularization module, performance of the ensemble learning model by utilizing residual diagnostics error Metrics, quality score in step 410.

The method (300) also includes anomaly tracking coupled with cumulative incremental learning module, wherein the ensemble learning model with a historical ensemble model and newly formed ensemble model by utilizing table merging or joining operation based for auto incremental active feature transfers learning, one or more features combination or band for anomaly tracking and flagship in step 420 and 430.

The method (300) also includes analysing, by the model diagnosis module, sensitivity and stability of the one or more features significant to each of the one or more grid-based bandit control trees and the ensemble learning model in step 440.

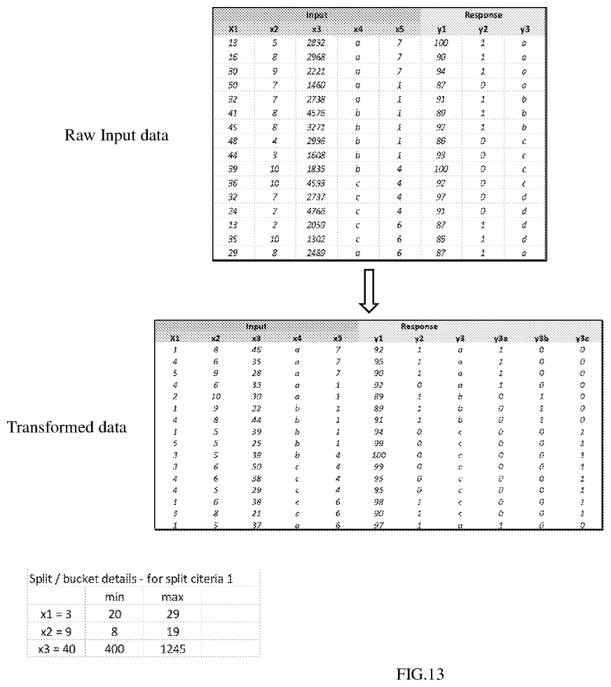

FIG. 13 (slide 4) is an exemplary bucket or splitting step, in accordance with an embodiment of the present disclosure. Data Transformation on Direct input and Transformed Feature, split Criteria—independent and Dependent (with max bucket size—10 to 100)->Bucket Details, Bucket size—based on cardinality and few other factor from input vars, using these Split Definition—transform data. For example, Bucket size—var1 with 2000 Unique pt.->40 to 50 bucket, var2 with 10000 to 50000 unique pts->100 bucket. Same Applicable for Response Var Y (Continuous)-> Percentile or Bucket [Response sensitive Segmentation exploratory modules such as regression2classification].

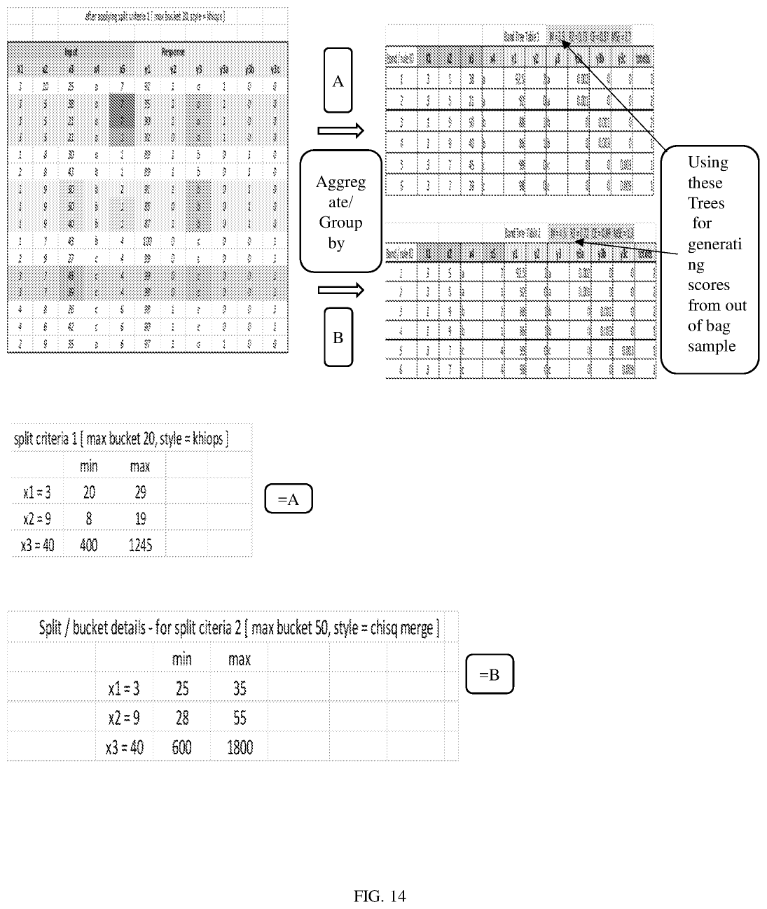

FIG. 14 (slide 5) is an exemplary band Tree Table formation after applying different split criteria, in accordance with an embodiment of the present disclosure. Split Criteria includes independent and Dependent (with max bucket size— 10 to 100). Variable subset-> N/2, Log(N), nCk: (K<N): continuous only (Categorical fixed), Bucket creation based on Split Criteria and Variable subset. Band Tree Table extraction for all split criteria and Variable subset combination.

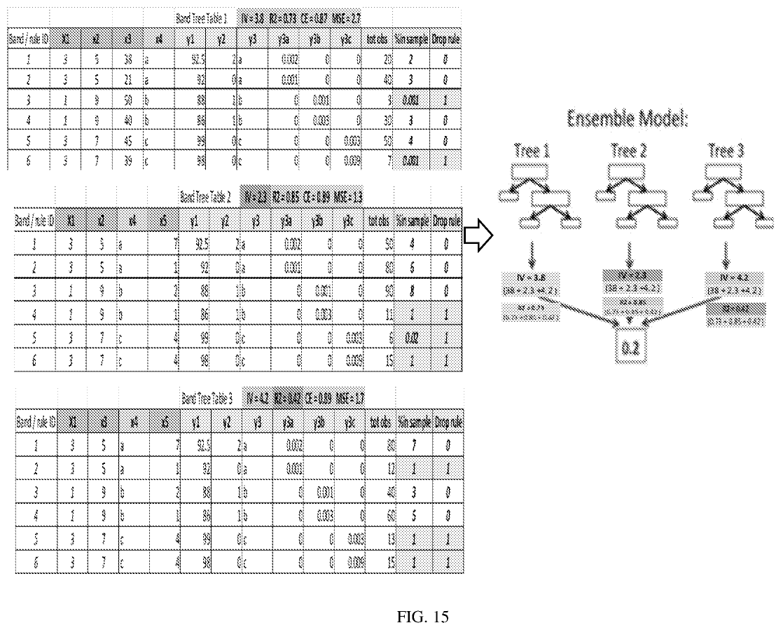

FIG. 15 (slide 6 and 7) is an exemplary Band Tree Table ensemble Prediction—Regularization step, in accordance with an embodiment of the present disclosure. Model building steps include data dimension: 10 M×200 Input [Full Batch— 2000], Response: Unit Count, Yield, Quality Class, Split Data into 70% Train [FB-1400]-30% Test [FB-600] [15% ITV, 15% OTV]. For 7 M Data points— 5 M for Generating tree, 2 M for 00B Validation. Regression classification includes binary and multiclass, Bandit control, optimal condition, risk level—scoring or ratio. Basic eda—uva, Correlation and BVA analysis, features cluster. Var type and granularity (unique pt or var Row size)—continuous and split eligible. Splitting criteria includes independent, Dependent. For all filtered set of vars or features-band or rule or branch (x10, y25, z47->response 0.70, X30, y5, z3-> response 0.80. Split vars with bin range 10-100. Create multiple Subset of vars vs split combination to create band tree or band forest. For each band get count of class, average of response for regression—average, median, classification—average of probability or ratio. Also add other uva, bva score mode, sd, woe, Snr and the like. One Subset of vars and one splitting criteria—one band tree. Like multiple diff Subset of vars and diff splitting criteria—multiple band tree or band forest. For prediction—get band level map based on band definition (×10:min x=2.5 max x=6.5; y25: min y=3.65 max y=50.45). Get response score generated from band tree table-tree level score. Get average at band forests level aggregation—for classification get weighted average. Weight—multivariate IV based from each band tree (scaled). For Regression-average or weighted—Central tendency.

In an embodiment, filter band tree based on information content and predictive power—IV, AUC, R2 is disclosed. Take scaled score for ensemble model—weighted score. Regularization and Prediction: Robustness check includes band pruning: rules filtering; filter band by number of supporting observations or high residual—rule fluctuation; band tree table weight: Predictive power associated to single tree, filter band tree tables by IV, info content weight, validate with training split rule to check psi, Surfaces or band tree fluctuation, for each data point or obs, Apply split details (bucket or band definition) to map specific band of a band tree table to generate responses score, Get response score from band 1 from band tree table 1, Band 2 from band tree table 2, and Band 3 from band tree table.

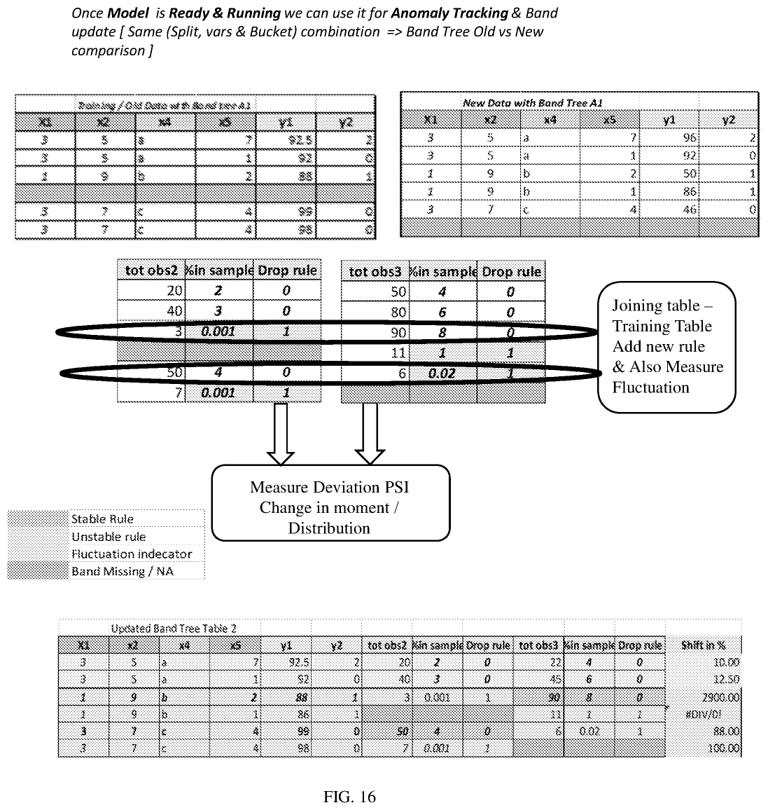

FIG. 16 (slide 10) is an exemplary Anomaly Tracking and Band update method, in accordance with an embodiment of the present disclosure. Join training band tree and New band tree—Anomaly Tracking and sensitivity analysis, Anomaly tracking detection as band or rule fluctuation. Some New Rule might appear in data and few old rule might come insignificant due to fluctuation. Once model is ready and running we can use it for Anomaly Tracking and Band update [Same (Split, vars and Bucket) combination=> Band Tree Old vs New comparison].

In an embodiment, inference code or Hypothesis or Model objects is disclosed. Basic eda—uva, Correlation and BVA analysis, features cluster includes extracted band or rules from training—boundary details for splitting criteria for all eligible vars (bucket or band definition), apply these rule and get response count or average from validation sample,

column join training band tree table and validation band tree table (which belongs to Anomaly Tracking and sensitivity analysis and or anomaly tracking as band update to track rule or band fluctuation), band score: measure residual, cov, Cross Entropy—relative, IV conditional expectation for both, training and validation response (oob validation and measurement), get band tree table score—psi, R2, Mae, CE, IV, sq error and finally filter or Prune or Prioritize band and band tree table (based on score or normalized).

The model building steps include data dimension: 10 M×200 Input [Full Batch— 2000], response: Unit Count, Yield, Quality Class, split data into 70% Train [FullBatch-30% Test [FullBatch-600] [15% InTimeValidation, 15% OutTimeValidation], and for 10 M Data points— 7 M for Generating tree, 1 M for 00B Validation and 2 M for testing.

The algorithm sequence includes:

1] Split and Bucket generation from data;

2] Data Transformation on Direct Input and Transformed Feature;

3] Band Tree Table formation after applying different split and Vars Combination;

4] Band Tree Table ensemble Prediction—Regression or Classification or Scoring;

5] Band Tree Table ensemble Prediction—Regularization;

6] Tune Hyperparameter of Learning Model; and

7] Model Diagnostics and Validation.

Once Model is Ready and Running we can use it for anomaly Tracking and incremental Band update, only applicable on Same (style of Split, vars and Bucket) combination=> Band Tree Training vs New comparison.

In an embodiment, hyperparameter of learning model is disclosed. The hyperparameters of the algorithm include split range—10-100 (continues vars with specific granularity), [Higher Split range—high variance model], [lower split range—low variance model], split or bucket size—based on cardinality and few other (SNR, SD) factor from input vars (unique pt. or tot obs), Var Subset index—sqrt(tot vars), n/2 and the like, split criteria—binning or discretization: ChiMerge, MDLP, CAIM, khiops, Adaptive Quantizer, Mutual Information based: PMI, MIC, change pt, cov or density or contour based and the like,

band tree Table Weight score— IV, AUC, R2 and the like, prediction—get count, average, weighted avg, class, probability, Out of bag sample size: 30%,

fluctuations pruning: true or false (warm up or incremental addition).

The model diagnostics include summary table including List of Tree Table with all quality scoring and contribution as weight, residual diagnostics details for weighting-ensemble, residual Diagnostics—Confusion Matrix, AUC— ROC, R2, MSE, MAE and the like, score quality checking, Rank order checking, stability and Sensitivity Analysis—Deviation in previous vs Current score and critical parameters, further diagnostics— IML XAI (Optional), feature Importance (Forest level) and Combined interaction Importance (Tree Level).

Various embodiments of the present disclosure provide a controllable learning framework which help in developing one or more learning models by utilizing machine learning or artificial intelligence techniques for one or more business problems in a much faster and easier way.

Moreover, the present disclosed framework utilizes an advanced machine learning with some additional features of anomaly tracking and sensitivity analysis for development of the learning models. Therefore, such advanced learning techniques provide better results in terms of performance in comparison to one or more existing techniques.

Furthermore, the present disclosed framework is applicable for solving one or more business problems associated with multiple industries such as pharmaceutical, healthcare, airlines, manufacturing and the like.

In addition, the present disclosed framework is applicable in several domains including, but not limited to, telecom industry, aviation industry, automotive industry, electrical or electronics industry, semiconductors industry—metrology, photolithography, material science industry, Consumers Analytics: retail industry, finance industry-risk and fraud analysis AML, travel and tourism industry, healthcare industry, pharmaceutical industry, information technology industry, Life science, agriculture engineering-Crop seed profiling treatment, bioinformatics, chemical and drug manufacturing, Internet and cyber security, industrial IoT or Sensor Analytics domain. It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

1. A system (100) for execution of a learning model in a controllable learning framework comprising:
a processing subsystem (105) hosted on a server (108), wherein the processing subsystem (105) is configured to execute on a network to control bidirectional communications among a plurality of modules comprising:
a surface learning or adaptive and active feature transfer learning module (110) configured to enable surface learning of a learning model for a plurality of input variables of an input dataset, wherein the learning model handles configuration recommendation with supervised and Unsupervised learning and anomaly tracking modules (125);
an optimization module (120) configured to:
provide a set of rules for the learning model to accomplish multi-criteria and multi-phase optimization of the plurality of input variables and a plurality of response variables of the input dataset associated with constrained objectives;
anomaly tracking module (125) configured to enable the learning model to track one or more anomalies in one or more parameters associated with the input dataset based on the fluctuation in the data specifically band or feature combination level, wherein for univariate and bivariate level similarity, dissimilarity and fluctuations measure for different time segments and different sample size using bucketized quality and tracking metrics for hypothesis test;
a response segmentation module (130) configured to enable segmentation of the one or more response variables of the input dataset by utilizing the learning model; and
a controllable segmentation module (140) configured to provide at least one of a controllable and configurable locality sensitive band embedding approach for plurality of input variables.

2. A system (150) for performing supervised learning using a controllable learning framework comprising:
a processing subsystem (115) hosted on a server (118), wherein the processing subsystem (115) is configured to execute on a network to control bidirectional communications among a plurality of modules comprising:
an input receiving module (155) configured to receive an input dataset comprising a plurality of input variables and one or more response variables arranged in a raw format;
a data transformation and feature creation module (160) operatively coupled to the input receiving module (155), wherein the data transformation module (160) is configured to:
determine one or more split criteria corresponding to each of the plurality of input variables and the one or more response variables of the input dataset; and
generate one or more data buckets from the input dataset for multiple types of transformation of the input dataset based on the one or more split criteria, cardinality of the plurality of input variables and one or more bucketing factors of the plurality of input variables;
a feature selection module (165) operatively coupled to the data transformation module (160), wherein the feature selection module (165) is configured to create one or more band tree tables upon selection of one or more features from transformed input dataset based on application of the one or more split criteria and the one or more bucketing factors;
an ensemble model generation module (170) operatively coupled to the feature selection module (165), wherein the ensemble model generation module (170) is configured to:
select one or more columns samples from each of the one or more band tree tables created using a sampling technique;
create one or more grid-based bandit control trees corresponding to each of the one or more column samples selected;
calculate one or more response scores corresponding to target variables based on each of the one or more grid-based bandit control trees created at a tree level;
generate an ensemble learning model for prediction of an outcome within an interval based on a predefined process by combining each of the one or more grid-based bandit control trees upon calculation of the one or more response scores; and
calculate an aggregated response score of the ensemble learning model for the prediction of the outcome by utilizing an aggregated or transformation function;
a model regularization module (175) operatively coupled to the ensemble model generation module (170), wherein the model regularization module (175) is configured to filter the one or more grid-based bandit control trees and the ensemble learning model based on each of the corresponding one or more response scores and the aggregated response score respectively for dashboard scoring or combined feature interaction or impact index, wherein the model regularization module utilizes a band level pruning technique and a tree level pruning technique; and
a model diagnosis module (180) operatively coupled to the ensemble model generation module (170) and the model regularization module (175), wherein the model diagnosis module (180) is configured to:
compare performance of the ensemble learning model by utilizing residual diagnostics error Metrics, quality score;
analyse sensitivity and stability of the one or more features significant to each of the one or more grid-based bandit control trees and the ensemble learning model; the anomaly tracking module (125) is configured to:
track unstability and fluctuations in plurality of input variables upon merging old band tree table data with new band tree table data based on one or more variables based on comparison of the ensemble model with a historical ensemble model upon incrementally updating the ensemble learning model; and
detect and mark fluctuations from the ensemble model based on analysis of the sensitivity and the stability of at feature combinations and band level.

3. The system (150) as claimed in claim 2, wherein the one or more split criteria comprises an independent split criteria associated with the one or more independent variables.

4. The system (150) as claimed in claim 2, wherein the system provides an interactive controls for supervised and unsupervised learning models based on user input, wherein supervised and unsupervised learning model is controlled by using custom split points from user.

5. The system (150) as claimed in claim 3, wherein the dependent split or discretization criteria comprises at least ChiMerge, minimum description length principle, khiops, adaptive quantizer, class-attribute interdependence maximization, pointwise mutual information—pmi or maximal information coefficient-mic.

6. The system (150) as claimed in claim 3, wherein the one or more split criteria comprises a dependent split criteria associated with the one or more response variables.

7. The system (150) as claimed in claim 6, wherein the independent split criteria comprises at least one of a flat cut criteria binning, percentile level criteria or decile level criteria.

8. The system (150) as claimed in claim 2, wherein the one or more bucketing factors comprises at least one of signal to noise ratio, standard deviation, variable subset index or a combination thereof.

9. The system (150) as claimed in claim 2, wherein the prediction at simultaneous learning of regression and classification at same instance comprises at least a binary classification, a multiclass classification, a regression and scoring.

10. The system (150) as claimed in claim 2, wherein the prediction comprises prediction with interval max—min, upper-lower bound at tree or forest level, rule extracted from the tree will have upper and lower bound and unit specification such as litre, gram, Amp, volt, ohm

11. The system (150) as claimed in claim 2, wherein the model diagnosis module with different errors Metrics and quality scores.

12. The system (150) as claimed in claim 9, wherein the binary classification and the class classification is performed based on calculation of weighted average, probability or class prediction for one or more bands of the one or more band tree tables, wherein the ensemble learning model utilized for the classification comprises both a generative and a discriminative model.

13. The system (150) as claimed in claim 9, wherein the regression is performed based on calculation of average, median of the one or more bands of the one or more band tree tables.

14. The system (150) as claimed in claim 1 further comprising an exploratory module comprising regression2classification.

15. The system (150) as claimed in claim 1, wherein the model diagnosis module is configured to perform error diagnostics and quality score check, sensitivity and stability analysis for a learning model at individual and the ensemble level for both supervised and unsupervised learning

16. The system (150) as claimed in claim 2, wherein the aggregated response score comprises a tree level pruning, wherein the tree level pruning for the prediction comprises at least one of, r-squared measure, mean absolute error, cross entropy, information content, information value, woe, area under curve of receiver operation characteristic, mean squared error, KS statistics score, or a combination thereof.

17. The system (150) as claimed in claim 2, wherein the one or more residual or model diagnostic parameters comprises at least one or more quality score, confusion matrix or rank order checking.

18. The system (100) as claimed in claim 1, wherein the segmentation technique comprises locality sensitive semantic band embedding—controllable segmentation iterative approach and a locality sensitive hierarchical band embedding—controllable segmentation non-iterative approach.

19. A method (300) comprising:
receiving, by an input receiving module an input dataset comprising a plurality of input variables and one or more response variables arranged in a raw format;
determining, by a data transformation module, one or more split criteria corresponding to each of the plurality of input variables and the one or more response variables of the input dataset;
generating, by the data transformation module, one or more data buckets from the input dataset for multiple types of transformation of the input dataset based on the one or more split criteria, cardinality of the plurality of input variables and one or more bucketing factors of the plurality of input variables;
creating, by a feature selection module, one or more band tree tables upon selection of one or more features from transformed input dataset based on application of the one or more split criteria and the one or more bucketing factors;
selecting, by an ensemble model generation module, one or more columns samples from each of the one or more band tree tables created using a sampling technique;
creating, by the ensemble model generation module, one or more grid-based bandit control trees corresponding to each of the one or more column samples selected;
calculating, by the ensemble model generation module, one or more response scores corresponding to target variables based on each of the one or more grid-based bandit control trees created at a tree level;
generating, by the ensemble model generation module, an ensemble learning model for prediction of an outcome within an interval based on a predefined process by combining each of the one or more grid-based bandit control trees upon calculation of the one or more response scores;
calculating, by the ensemble model generation module, an aggregated or transformed response score of the ensemble learning model for the prediction of the outcome by utilizing an aggregated or transformation function;
filtering, by a model regularization module, the one or more grid-based bandit control trees and the ensemble learning model based on each of the corresponding one or more response scores and the aggregated response score respectively (400);
anomaly tracking coupled with cumulative incremental learning module or band update module, wherein the ensemble learning model with a historical ensemble model and newly formed ensemble model by utilizing table merging or joining operation based for auto incremental active feature transfers learning, one or more features combination or band for anomaly tracking and flagship the changes;
analysing, by the model diagnosis module, sensitivity and stability of the one or more features significant to each of the grid-based bandit control trees and the ensemble learning model.
